(19) United States
(12) Patent Application Publication
(10) Pub. No.: US 2024/0303391 A1
(43) Pub. Date: Sep. 12, 2024

(54) METHOD FOR CONSTRUCTING SECURITY REGION OF INTEGRATED ELECTRICITY AND HEATING SYSTEM

(71) Applicants: SOUTHEAST UNIVERSITY, Nanjing (CN); ELECTRIC POWER RESEARCH INSTITUTE OF YUNNAN POWER GRID CO., LTD., Kunming (CN)

(72) Inventors: Wei GU, Nanjing (CN); Suhan ZHANG, Nanjing (CN); Hai LU, Nanjing (CN); Enbo LUO, Nanjing (CN)

(21) Appl. No.: 18/552,284

(22) PCT Filed: Oct. 27, 2022
(86) PCT No.: PCT/CN2022/127816

§ 371 Date: Sep. 25, 2023

(30) Foreign Application Priority Data
Oct. 9, 2022 (CN) 202211226937.1

(51) Int. Cl. G06F 30/20

(52) U.S. Cl. CPC G06F 30/20

(57) ABSTRACT

Disclosed is a method for constructing a security region of an integrated electricity and heating system, falling into the field of energy system modeling and operational analysis. The method specifically includes: establishing a dynamic model of the integrated electricity and heating system, including a power system model, a quality-regulated heating system dynamic model, and a combined heat and power unit dynamic model; constructing, in combination with operational security constraints, a security region model of the integrated electricity and heating system considering thermal dynamics; and solving, aiming at nonlinear and nonconvex characteristics of the security region of the integrated electricity and heating system, a security region boundary by an optimization-check-based concave hull method. Compared with the related art, the method considers thermal dynamics in the integrated electricity and heating system, and accurately depicts operational features. Limited operation points are solved through the optimization-check-based concave hull method, thus guaranteeing security.

### TECHNICAL FIELD

The present disclosure relates to the field of energy system modeling and operational analysis, and in particular, to a method for constructing a security region of an integrated electricity and heating system.

### BACKGROUND

Due to the worldwide energy crisis and environmental problems, a heating system is gradually changing from traditional coal supply to electricity supply, so as to improve energy utilization efficiency and reduce carbon emissions. Under this background, an integrated electricity and heating system has been widely developed. Coupling equipment such as a combined heat and power unit is used as key equipment for cooperative optimization and joint control. However, a tight coupling between a power system and the heating system also increases the risk of cascade faults and poses an additional threat to the power system. For example, a snowstorm in a certain area caused a large-scale power outage and heat supply interruption in the area, which exposed the fragility of the integrated electricity and heating system. Therefore, it is of great significance to comprehensively analyze the operational security of the integrated electricity and heating system.

The existing research generally solves a security region by traversal simulation or hyperplane fitting, but the traversal simulation method needs to generate enough scenarios for analysis, which is not suitable for online analysis. However, the hyperplane fitting needs to simplify a model greatly, and the accuracy of the result is low. In addition, thermal dynamics is an important factor affecting the security of combined operation in the integrated electricity and heating system. However, this characteristic is generally ignored in the existing research, which leads to further reduction of the accuracy of the constructed security region.

### SUMMARY

In view of the deficiency of the related art, the present disclosure provides a method for constructing a security region of an integrated electricity and heating system.

The object of the present disclosure is achieved by the following technical solutions.

The method for constructing the security region of the integrated electricity and heating system includes the following steps:
establishing a dynamic model of the integrated electricity and heating system, including a power system model established based on power conservation, a dynamic model of a quality-regulated heating system model established based on pipe heat transfer, node heat exchange, node temperature fusion, and pipe-node temperature association, and a dynamic model of a combined heat and power unit constructed based on production capacity of the combined heat and power unit; and constructing, in combination with operational security constraints of the dynamic model of the integrated electricity and heating system, a security region model of the integrated electricity and heating system, solving, aiming at nonlinear and nonconvex characteristics of the security region model of the integrated electricity and heating system, a security region boundary by adopting a concave hull method, and depicting the security region.

Further, the power system model includes a power conservation equation and a power conservation equation at nodes and branches:

$${P}_{Gi , t} - {P}_{Li , t} = {V}_{i , t} {\sum }_{j ∈ i} {V}_{j , t} ( {G}_{ij} cos {θ}_{ij , t} + {B}_{ij} sin {θ}_{ij , t} ) \qquad ( 1 )$$

$${Q}_{Gi , t} - {Q}_{Li , t} = {V}_{i , t} {\sum }_{j ∈ i} {V}_{j , t} ( {G}_{ij} sin {θ}_{ij , t} - {B}_{ij} cos {θ}_{ij , t} ) \qquad ( 2 )$$

$${P}_{l , ij , t} = {V}_{i , t} {V}_{j , t} ( {G}_{ij} cos {θ}_{ij , t} + {B}_{ij} sin {θ}_{ij , t} ) - {G}_{ij} {V}_{i , t}^{2} \qquad ( 3 )$$

$${Q}_{l , ij , t} = {V}_{i , t} {V}_{j , t} ( {G}_{ij} sin {θ}_{ij , t} - {B}_{ij} cos {θ}_{ij , t} ) + {B}_{ij} {V}_{i , t}^{2} \qquad ( 4 )$$

where i and j represent node numbers respectively, t is a time flag, V_{i,t} represents a voltage amplitude of node i at time t, P_{Gi,t} and P_{Li,t} represent a generator produced active power and a load consumed active power of node i at time t, Q_{Gi,t} and Q_{Li,t} represent a generator produced reactive power and a load consumed reactive power of node i at time t, Gᵢⱼ and Bᵢⱼ represent conductance and susceptance between node i and node j, θ_{ij,t} represents a phase angle difference between node i and node j at time t, and P_{1,ij,t} and Q_{1,ij,t} represent an active power and a reactive power transmitted between node i and node j at time t.

Further, the dynamic model of the quality-regulated heating system model includes a pipe heat transfer equation, a node heat exchange equation, a node temperature fusion equation, and a pipe-node temperature association equation:

$$\begin{matrix}\frac{\partial {T}_{j , x , t}}{\partial t} + {v}_{j} \frac{\partial {T}_{j , x , t}}{\partial x} + \frac{{v}_{j}}{{C}_{w} {m}_{j} {λ}_{j}} {T}_{j , x , t} = 0 & j ∈ Φ\end{matrix} \qquad ( 5 )$$

$$\begin{matrix}{ϕ}_{i , t} = {C}_{w} {m}_{i} ( {T}_{ι , t}^{s} - {T}_{ι , t}^{r} ) & i ∈ Θ\end{matrix} \qquad ( 6 )$$

$$\begin{matrix}{T}_{j , t} {\sum }_{k ∈ {Φ}_{j}^{i}} {m}_{k} = {\sum }_{k ∈ {Φ}_{j}^{o}} {m}_{k} {T}_{k , x = L , t} & j ∈ Θ\end{matrix} \qquad ( 7 )$$

$$\begin{matrix}{T}_{k , x = 0 , t} = {T}_{j , t} & j ∈ Θ , k ∈ {Φ}_{j}^{i}\end{matrix} \qquad ( 8 )$$

where Φ and Θ represent a pipe set and a node set of the heating system respectively, T_{j,x,t} represents a relative temperature at x on pipe j at time t, vⱼ represents a water flow velocity of pipe j, C_{w} is the specific heat capacity of water, mⱼ is the mass flow rate of pipe water flow, λⱼ represents a thermal resistance coefficient of pipe j, ϕ_{i,t} represents a consumed thermal power of node i at time t, Ts i,t and T_{i,t}^{r} represent relative water supply and return temperatures of node i at time t, L represents a pipe length, and Φⱼⁱ and Φⱼ^{o} represent pipe sets flowing into and out of node j respectively.

An analytical solution of Equation (5) may be represented as:

$${T}_{j , x , t} = {φ}_{j , x - ν t} {e}^{- νt / {C}_{w} {m}_{j} {λ}_{j}} [ δ ( t ) - δ ( t - x / v ) ] + {ψ}_{j , t - x / v} {e}^{- x / {C}_{w} {m}_{j} {λ}_{j}} δ ( t - x / v ) 0 \leq x \leq L , j ∈ Φ \qquad ( 9 )$$

where δ represents a step function, φ(j,x−vt) represents a temperature distribution at x−vt on pipe j at an initial time, and ψ(j,t−x/v) represents a temperature distribution at an inlet of pipe j at time t−x/v.

Further, the dynamic model of the combined heat and power unit includes a coal-fired boiler, a steam turbine, a generator, and a steam-water heat exchanger, and the dynamic model of the combined heat and power unit is constructed as follows:
input fuel of the coal-fired boiler is represented as:

$${ϕ}_{B , t} = {K}_{B 1} {m}_{B , t} \qquad ( 10 )$$

where K_{B1} is a unit heat value of the fuel, ϕ_{B,t} represents input heat of the boiler at time t, and m_{B,t} represents a mass flow rate inputted to the boiler at time t;
energy conservation in the boiler is represented as:

$${K}_{B 3} \frac{{dp}_{B , t}}{d t} = - {K}_{T 1} {p}_{T , t} - {ϕ}_{H , t} + {K}_{B 2} {ϕ}_{B , t} \qquad ( 11 )$$

where K_{B2} is combustion efficiency of the boiler, K_{B3} is a heat storage coefficient of the boiler, K_{T1} is a gain of the boiler, p_{T,t} is a pressure of the steam turbine at time t, ϕ_{H,t} represents a heat supply power at time t, and p_{B,t} is a pressure of the coal-fired boiler at time t;
energy conservation in the steam turbine is represented as:

$${K}_{T 4} \frac{{dP}_{T , t}}{dt} = - {P}_{T , t} + {K}_{T 2} {K}_{T 3} {p}_{T , t} \qquad ( 12 )$$

where K_{T2} is an inlet opening of the steam turbine, K_{T3} is a gain of the steam turbine, K_{T4} is a delay coefficient of the steam turbine, and P_{T,t} is an electric power generated by the steam turbine at time t;
the pressure of the coal-fired boiler and the pressure of the steam turbine satisfy:

$${p}_{T , t} = {p}_{B , t} - {K}_{B 4} {K}_{B 2}^{1.3} {ϕ}_{B , t}^{1.3} \qquad ( 13 )$$

where K_{B4} is a friction resistance coefficient of the boiler;
energy conservation in the steam-water heat exchanger is represented as:

$$\frac{d {T}_{H , t}^{o}}{d t} = \frac{{ϕ}_{H , t}}{{K}_{H 1}} - \frac{{C}_{w} {m}_{H} ( {T}_{H , t}^{o} - {T}_{H , t}^{i} )}{{K}_{H 1}} - \frac{{K}_{H 2} {T}_{H , t}^{o}}{{K}_{H 1}} \qquad ( 14 )$$

where K_{H1} represents a heat storage coefficient of the heat exchanger, K_{H2} represents a thermal conductivity coefficient of the heat exchanger, m_{H,t} represents a mass flow rate of water flow for heat exchange in the heat exchanger at time t, T_{H,t}ⁱ and T_{H,t}^{o} represent inlet and outlet temperatures of the steam-water heat exchanger at time t; and
an ordinary differential equation is discretized by using an implicit Euler method, and Equations (11), (12), and (14) are respectively discretized as:

$${p}_{B , t} = \frac{Δ t ( {K}_{B 2} {K}_{B 1} {m}_{B , t} - {K}_{T 1} {p}_{T , t} - {ϕ}_{S , t} )}{{K}_{B 3}} + {p}_{B , t - Δ t} \qquad ( 15 )$$

$${P}_{T , t} = \frac{Δ t ( {K}_{T 2} {K}_{T 3} {p}_{T , t} - {P}_{T , t} )}{{K}_{T 4}} + {P}_{T , t - Δ t} \qquad ( 16 )$$

$${T}_{H , t}^{o} = \frac{{K}_{H 1} {T}_{H , t - Δ t}^{o} + Δ t {ϕ}_{H , t} + Δ t {C}_{p} {m}_{H , t} {T}_{H , t}^{i}}{( {K}_{H 1} + Δ t {C}_{w} {m}_{H} + Δ {tK}_{H 2} )} \qquad ( 17 )$$

where Δt is a time step, and P_{B,t-Δt}, P_{T,t-Δt} and T_{H,t-Δt}^{e} represent a pressure of the coal-fired boiler, an electric power inputted to the steam turbine, and an outlet temperature of the steam-water heat exchanger at time t−Δt.

Further, the operational security constraints of the dynamic model of the integrated electricity and heating system include operational security constraints of the power system model, operational security constraints of the dynamic model of the quality-regulated heating system model, and operational security constraints of the dynamic model of the combined heat and power unit:
the operational security constraints of the power system include branch transmission power constraints, upper and lower limit constraints of generator active and reactive powers, upper and lower limit constraints of node voltage amplitude, and voltage phase angle constraints, as shown in Equations (18) to (21) respectively:

$$\sqrt{{P}_{l , ij , t}^{2} + {Q}_{l , ij , t}^{2}} \leq {S}_{l , ij}^{max} \qquad ( 18 )$$

$${P}_{Gi}^{min} \leq {P}_{Gi , t} \leq {P}_{Gi}^{max} , {Q}_{Gi}^{min} \leq {Q}_{Gi , t} \leq {Q}_{Gi}^{max} \qquad ( 19 )$$

$${V}_{i}^{min} \leq {V}_{i , t} \leq {V}_{i}^{max} \qquad ( 20 )$$

$$- π \leq {θ}_{i , t} \leq π \qquad ( 21 )$$

where S_{l,ij}^{max} represents a maximum apparent power transmitted between node i and node j, P_{Gi}^{min} and Q_{Gi}^{min} respectively represent the lower limits of the generator active and reactive powers at node i, P_{Gi}^{min} and Q_{Gi}^{min} respectively represent the upper limits of the generator active and reactive powers at node i, and Vᵢ^{min} and Vᵢ^{max} respectively represent the lower and upper limits of the voltage amplitude at node i;
coupling constraints of the power system and the combined heat and power unit are represented as:

$${P}_{T , t} = {P}_{G , t} \qquad ( 22 )$$

the operational security constraints of the quality-regulated heating system include node water supply and return temperature constraints, which are represented as:

T_{i,t}^{s,min}≤T_{i,t}^{s}≤T_{i,t}^{s,max},T_{i,t}^{r,min}≤T_{i,t}^{r}≤T_{i,t}^{r,max}iϵΘ (23)
where T_{i,t}^{s,max} and T_{i,t}^{s,min} represent the upper and lower limits of the water supply temperature of node i at time t, T_{i,t}^{r,max} and T_{i,t}^{r,min} represent the upper and lower limits of the water return temperature of node i at time t, and coupling constraints of the heating system and the combined heat and power unit may be represented as:

$${m}_{G} = - {m}_{H} \qquad ( 24 )$$

$${T}_{H , t}^{o} = {T}_{G , t}^{s} , {T}_{H , t}^{i} = {T}_{G , t}^{r} \qquad ( 25 )$$

where T_{G,t}^{s} represents the water supply temperature of a heat source node at time t, T_{G,t}^{r} represents the water return temperature of the heat source node at time t, Equation (24) shows that the inlet and outlet mass flow rate of the steam-water heat exchanger is the mass flow rate of the heat source node, and Equation (25) shows that the outlet temperature of the steam-water heat exchanger is the water supply temperature of the heat source node and the inlet temperature of the steam-water heat exchanger is the water return temperature of the heat source node; and
the operational security constraints of the combined heat and power unit mainly include mass flow rate constraints of input fuel, pressure constraints of the coal-fired boiler, pressure constraints of the steam turbine, heating power constraints, supply power constraints, and electric heating power coupling constraints, as shown in Equations (26) to (31)(31) respectively:

$${m}_{B}^{min} \leq {m}_{B , t} \leq {m}_{B}^{max} \qquad ( 26 )$$

$${p}_{B}^{min} \leq {p}_{B , t} \leq {p}_{B}^{max} \qquad ( 27 )$$

$${p}_{T}^{min} \leq {p}_{T , t} \leq {p}_{T}^{max} \qquad ( 28 )$$

$${ϕ}_{H}^{min} \leq {ϕ}_{H , t} \leq {ϕ}_{H}^{max} \qquad ( 29 )$$

$${P}_{T}^{min} \leq {P}_{T , t} \leq {P}_{T}^{max} \qquad ( 30 )$$

$${P}_{T , t} + {ϕ}_{H , t} \leq {K}_{B 2} {ϕ}_{B , t} . \qquad ( 31 )$$

Further, the security region model of the integrated electricity and heating system is constructed as follows:
variables of the integrated electricity and heating system at any time t are divided into a controllable variable Xₜ and a controlled variable Yₜ, the controllable variable includes an active power of a generator in the power system, input fuel mass in the combined heat and power unit, a heat supply power of a heat source in the heating system, and a water supply temperature, which are respectively represented as:

$$\{ \begin{matrix}{X}_{t} = \{ {X}_{t}^{e} , {X}_{t}^{c} , {X}_{t}^{h} \} \\ {X}_{t}^{e} = \{ {P}_{G , t} \} , {X}_{t}^{c} = \{ {m}_{B , t} \} , {X}_{t}^{h} = \{ {ϕ}_{G , t} , {T}_{G , t}^{s} \}\end{matrix} \qquad ( 32 )$$

where Xₜ^{e} represents the controllable variable in the power system at time t, Xₜ^{h} represents the controllable variable in the heating system at time t, Xₜ^{c} represents the controllable variable in the combined heat and power unit at time t, and ϕ_{G,t} represents the heat supply power of the heat source node at time t;
the controlled variable includes branch active and reactive powers in the power system, a node voltage amplitude and phase angle, a water return temperature of the heat source node in the heating system, a water supply temperature of a load node, input heat in the combined heat and power unit, pressures of the coal-fired boiler and the steam turbine, an outlet temperature of the steam-water heat exchanger, and a supply power, which are represented as:

$$\{ \begin{matrix}{Y}_{t} = \{ {Y}_{t}^{e} , {Y}_{t}^{c} , {Y}_{t}^{h} \} \\ {Y}_{t}^{e} = \{ {P}_{l , t} , {Q}_{l , t} , {V}_{t} , {θ}_{t} \} \\ {Y}_{t}^{c} = \{ {ϕ}_{B , t} , {p}_{B , t} , {p}_{T , t} , {P}_{T , t} , {T}_{S , t}^{o} \} \\ {Y}_{t}^{h} = \{ {T}_{G , t}^{r} , {T}_{D , t}^{s} \}\end{matrix} \qquad ( 33 )$$

where Yₜ^{e} represents the controlled variable in the power system at time t, Y_{y}^{h} represents the controlled variable in the heating system at time t, Yₜ^{c} represents the controlled variable in the combined heat and power unit at time t, and T_{D,t}^{s} represents the water supply temperature of the load node at time t;
the security region model of the integrated electricity and heating system considering thermal dynamics is represented as:

$${Ω}_{j} = \{ \begin{matrix}{X}_{j} \vert f ( {X}_{1} , … , {X}_{j} , {Y}_{1} , … , {Y}_{j} ) = 0 , \\ g ( {X}_{1} , … , {X}_{j} , {Y}_{1} , … , {Y}_{j} ) \leq 0\end{matrix} \} \qquad ( 34 )$$

where Ωⱼ represents the security region, X₁, . . . , Xⱼ represent the controllable variables from time 1 to time j, Y₁, . . . , Yⱼ represent the controlled variables from time 1 to time j, f is an equality constraint set in the security region model, including Equations (1) to (4), (6) to (10), (13), (15) to (17), (22), (24), and (25), and g is an inequality constraint set in the security region model, including Equations (18) to (21), (23), (26) to (31).

Further, the process of solving, aiming at nonlinear and nonconvex characteristics of the security region of the integrated electricity and heating system, a security region boundary by adopting a concave hull method and depicting the security region includes the following steps:
transforming a security region modeling problem into a security region boundary solving problem, transforming Equation (34) into two groups of nonlinear optimization problems, and depicting the security region boundary by solving a limit operation point, the two groups of optimization problems being respectively represented as:

$$min {F}_{j , i} \qquad ( 35 )$$

$$s . t . f ( {X}_{1} , … , {X}_{j} , {Y}_{1} , … , {Y}_{j} ) = 0$$

$${A}_{1} \leq g ( {X}_{1} , … , {X}_{j} , {Y}_{1} , … , {Y}_{j} ) \leq {A}_{2}$$

$${F}_{j} = [ {X}_{j} , {Y}_{j} ] , ∀ {F}_{j , i} ∈ {F}_{j}$$

$$max {F}_{j , i} \qquad ( 36 )$$

$$s . t . f ( {X}_{1} , … , {X}_{j} , {Y}_{1} , … , {Y}_{j} ) = 0$$

$${A}_{1} \leq g ( {X}_{1} , … , {X}_{j} , {Y}_{1} , … , {Y}_{j} ) \leq {A}_{2}$$

$${F}_{j} = [ {X}_{j} , {Y}_{j} ] , ∀ {F}_{j , i} ∈ {F}_{j}$$

where Equation (35) and Equation (36) respectively represent operational upper and lower limits of the integrated electricity and heating system considering thermal dynamics, Fⱼ represents all state variable vectors in the integrated electricity and heating system at time j, F_{j,i} represents an i^{th} variable in the integrated electricity and heating system at time j, A₁ represents a lower limit vector of an inequality constraint, and A₂ represents an upper limit vector of the inequality constraint;
performing security check on the limit operation point solved by Equation (35) and Equation (36) in view of the nonconvex and nonlinear features of the security region model, defining ε as a security margin, and if the solved i^{th} variable F_{j,i} in the integrated electricity and heating system at time j violates the upper limit of security operation, modifying the corresponding optimization problem as:

$$min {F}_{j , i} \qquad ( 37 )$$

$$s . t . f ( {X}_{1} , … , {X}_{j} , {Y}_{1} , … , {Y}_{j} ) = 0$$

$${A}_{1} \leq g ( {X}_{1} , … , {X}_{j} , {Y}_{1} , … , {Y}_{j} ) \leq {A}_{2} - ε$$

if the solved i^{th} variable F_{j,i} in the integrated electricity and heating system at time j violates the upper limit of security operation, modifying the corresponding optimization problem as:

$$min {F}_{j , i} \qquad ( 38 )$$

$$s . t . f ( {X}_{1} , … , {X}_{j} , {Y}_{1} , … , {Y}_{j} ) = 0$$

$${A}_{1} + ε \leq g ( {X}_{1} , … , {X}_{j} , {Y}_{1} , … , {Y}_{j} ) \leq {A}_{2}$$

depicting the security region boundary by adopting the concave hull method according to the limit operation point satisfying the security check, and determining the security region of the integrated electricity and heating system considering thermal dynamics.

The present disclosure has the following beneficial effects.

Compared with the related art, the method considers thermal dynamics from equipment and network sides in an integrated electricity and heating system, and accurately depicts operational features of the integrated electricity and heating system. A limit operation point is solved through an optimization-check-based concave hull method, thus guaranteeing absolute security of the solved security region, and providing theoretical guidance for operational analysis of the integrated electricity and heating system.

### BRIEF DESCRIPTION OF THE DRAWINGS

The present disclosure will be further described with reference to the accompanying drawings.

FIG. 1 is a structural diagram of a typical integrated electricity and heating system in an embodiment of the present disclosure.

FIG. 2 is a flowchart of a method for constructing a security region of an integrated electricity and heating system considering thermal dynamics according to an embodiment of the present disclosure.

FIG. 3 is a topological diagram of an integrated electricity and heating system in an embodiment of the present disclosure.

FIG. 4 is a topological diagram of a heating system in an embodiment of the present disclosure.

FIG. 5 is a time-varying curve graph of an area of a security region formed by generator 1 and generator 2 of a power system in an embodiment of the present disclosure.

### DETAILED DESCRIPTION

The technical solutions in this embodiment of the present disclosure will be clearly and completely described below in combination with the figures in this embodiment of the present disclosure. Obviously, the described embodiments are only a few, but not all, embodiments of the present disclosure. Based on this embodiment of the present disclosure, all the other embodiments obtained by those of ordinary skill in the art without involving any inventive effort may fall within the scope of protection of the present disclosure.

In the descriptions of this specification, references to descriptions of the terms “one embodiment”, “example”, “specific example”, etc. mean that a particular feature, structure, material, or characteristic described in connection with this embodiment or example is included in at least one embodiment or example of the present disclosure. In this specification, schematic representations of the above terms do not necessarily refer to the same embodiment or example. Moreover, the particular feature, structure, material, or characteristic described may be combined in any suitable manner in any one or more embodiments or examples.

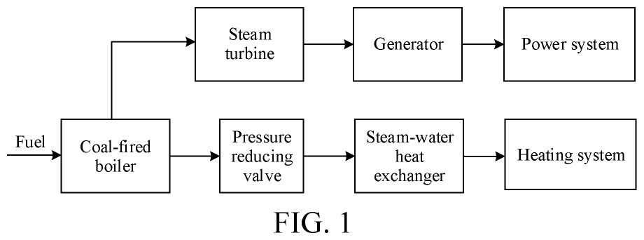

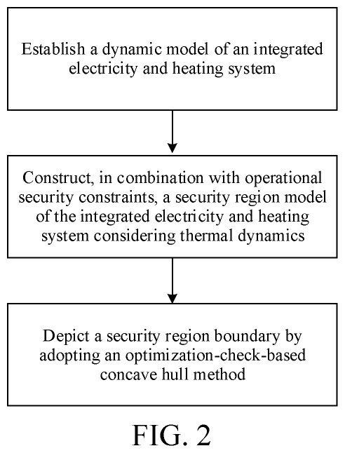

Aiming at the typical integrated electricity and heating system shown in FIG. 1, a method for constructing a security region of an integrated electricity and heating system considering thermal dynamics is provided. As shown in FIG. 2, the method includes the following steps.

A dynamic model of the integrated electricity and heating system is established, including a power system model, a dynamic model of a quality-regulated heating system model, and a dynamic model of a combined heat and power unit.

In combination with operational security constraints, a security region model of the integrated electricity and heating system considering thermal dynamics is constructed.

Aiming at nonlinear and nonconvex characteristics of the security region model of the integrated electricity and heating system, a security region boundary is solved by adopting an optimization-check-based concave hull method, and the security region is depicted.

The process of establishing a dynamic model of the integrated electricity and heating system, including a power system model, a dynamic model of a quality-regulated heating system model, and a dynamic model of a combined heat and power unit includes the following steps.

The power system model is established, including a power conservation equation and a power conservation equation at nodes and branches:

$${P}_{Gi , t} - {P}_{Li , t} = {V}_{i , t} {\sum }_{j ∈ i} {V}_{j , t} ( {G}_{ij} cos {θ}_{ij , t} + {B}_{ij} sin {θ}_{ij , t} ) \qquad ( 1 )$$

$${Q}_{Gi , t} - {Q}_{Li , t} = {V}_{i , t} {\sum }_{j ∈ i} {V}_{j , t} ( {G}_{ij} sin {θ}_{ij , t} - {B}_{ij} cos {θ}_{ij , t} ) \qquad ( 2 )$$

$${P}_{l , ij , t} = {V}_{i , t} {V}_{j , t} ( {G}_{ij} cos {θ}_{ij , t} + {B}_{ij} sin {θ}_{ij , t} ) - {G}_{ij} {V}_{i , t}^{2} \qquad ( 3 )$$

$${Q}_{l , ij , t} = {V}_{i , t} {V}_{j , t} ( {G}_{ij} sin {θ}_{ij , t} - {B}_{ij} cos {θ}_{{ij , t}_{}} ) + {B}_{ij} {V}_{i , t}^{2} \qquad ( 4 )$$

where i and j represent node numbers respectively, t is a time flag, V_{i,t} represents a voltage amplitude of node i at time t, P_{Gi,t} and P_{Li,t} represent a generator produced active power and a load consumed active power of node i at time t, Q^{Gi,t} and Q_{Li,t} represent a generator produced active power and a load consumed active power of node i at time t, Gᵢⱼ and Bᵢⱼ represent conductance and susceptance between node i and node j, θ_{ij,t} represents a phase angle difference between node i and node j at time t, and P_{1,ij,t} and Q_{1,ij,t} represent an active power and a reactive power transmitted between node i and node j at time t.

The dynamic model of the quality-regulated heating system model is established, including a pipe heat transfer equation, a node heat exchange equation, a node temperature fusion equation, and a pipe-node temperature association equation, which are respectively shown in Equations (5) to (8):

$$\frac{\partial {T}_{j , x , t}}{\partial t} + {v}_{j} \frac{\partial {T}_{j , x , t}}{\partial x} + \frac{{v}_{j}}{{C}_{w} {m}_{j} {λ}_{j}} {T}_{j , x , t} = 0 j ∈ Φ \qquad ( 5 )$$

$${ϕ}_{i , t} = {C}_{w} {m}_{i} ( {T}_{i , t}^{s} - {T}_{i , t}^{r} ) i ∈ Θ \qquad ( 6 )$$

$${T}_{j , t} {\sum }_{k ∈ {Φ}_{j}^{i}} {m}_{k} = {\sum }_{k ∈ {Φ}_{j}^{o}} {m}_{k} {T}_{k , x = L , t} j ∈ Θ \qquad ( 7 )$$

$${T}_{k , x = 0 , t} = {T}_{j , t} j ∈ Θ , k ∈ {Φ}_{j}^{i} \qquad ( 8 )$$

where Φ and Θ represent a pipe set and a node set of the heating system respectively, T_{j,x,t} represents a relative temperature at x on pipe j at time t, vⱼ represents a water flow velocity of pipe j, C_{w} is the specific heat capacity of water, mⱼ is the mass flow rate of pipe water flow, λⱼ represents a thermal resistance coefficient of pipe j, ϕ_{i,t} represents a consumed thermal power of node i at time t, T_{i,i}^{s} and T_{i,t}^{r} represent relative water supply and return temperatures of node i at time t, L represents a pipe length, and Φⱼⁱ and Φⱼ^{o} represent pipe sets flowing into and out of node j respectively.

An analytical solution of Equation (5) may be represented as:

$$( 9 )$$

$${T}_{j , x , t} = {φ}_{j , x - vt} {e}^{- vt / {C}_{w} {m}_{j} {λ}_{j}} [ δ ( t ) - δ ( t - x / v ) ] + {ψ}_{j , t - x / v} {e}^{- x / {C}_{w} {m}_{j} {λ}_{j}} δ ( t - x / v )$$

$$0 \leq x \leq L , j ∈ Φ$$

where δ represents a step function, φ(j,x−vt) represents a temperature distribution at x−vt on pipe j at an initial time, and ψ(j,t−x/v) represents a temperature distribution at an inlet of pipe j at time t−x/v.

The dynamic model of the combined heat and power unit is established, including a coal-fired boiler, a steam turbine, a generator, and a steam-water heat exchanger. Input fuel of the coal-fired boiler may be represented as:

$${ϕ}_{B , t} = {K}_{B 1} {m}_{B , t} \qquad ( 10 )$$

where K_{B1} is a unit heat value of the fuel, ϕ_{B,t} represents input heat of the boiler at time t, and m_{B,t} represents a mass flow rate inputted to the boiler at time t. Energy conservation in the boiler is represented as:

$${K}_{B 3} \frac{{dp}_{B , t}}{dt} = - {K}_{T 1} {p}_{T , t} - {ϕ}_{H , t} + {K}_{B 2} {ϕ}_{B , t} \qquad ( 11 )$$

where K_{B2} is combustion efficiency of the boiler, K_{B3} is a heat storage coefficient of the boiler, K_{T1} is a gain of the boiler, p_{T,t} is a pressure of the steam turbine at time t, ϕ_{H,t} represents a heat supply power at time t, and p_{B,t} is a pressure of the coal-fired boiler at time t. Energy conservation in the steam turbine may be represented as:

$${K}_{T 4} \frac{{dP}_{T , t}}{dt} = - {P}_{T , t} + {K}_{T 2} {K}_{T 3} {p}_{T , t} \qquad ( 12 )$$

where K_{T2} is an inlet opening of the steam turbine, K_{T3} is a gain of the steam turbine, K_{T4} is a delay coefficient of the steam turbine, and P_{T,t} is an electric power generated by the steam turbine at time t. The pressure of the coal-fired boiler and the pressure of the steam turbine satisfy:

$${p}_{T , t} = {P}_{B , t} - {K}_{B 4} {K}_{B 2}^{1.3} {ϕ}_{B , t}^{1.3} \qquad ( 13 )$$

where K_{B4} is a friction resistance coefficient of the boiler. Energy conservation in the steam-water heat exchanger may be represented as:

$$\frac{{dT}_{H , t}^{o}}{dt} = \frac{{ϕ}_{H , t}}{{K}_{H 1}} - \frac{{C}_{w} {m}_{H} ( {T}_{H , t}^{o} - {T}_{H , t}^{i} )}{{K}_{H 1}} - \frac{{K}_{H 2} {T}_{H , t}^{o}}{{K}_{H 1}} \qquad ( 14 )$$

where K_{H1} represents a heat storage coefficient of the heat exchanger, K_{H2} represents a thermal conductivity coefficient of the heat exchanger, m_{H,t} represents a mass flow rate of water flow for heat exchange in the heat exchanger at time t, T^{H,t}ᵢ and T_{H,t}^{o} represent inlet and outlet temperatures of the steam-water heat exchanger at time t.

An ordinary differential equation is discretized by using an implicit Euler method, and Equations (11), (12), and (14) may be respectively discretized as:

$${p}_{B , t} = \frac{Δ t ( {K}_{B 2} {K}_{B 1} {m}_{B , t} - {K}_{T 1} {p}_{T , t} - {ϕ}_{S , t} )}{{K}_{B 3}} + {p}_{B , t - Δ t} \qquad ( 15 )$$

$${P}_{T , t} = \frac{Δ t ( {K}_{T 2} {K}_{T 3} {p}_{T , t} - {P}_{T , t} )}{{K}_{T 4}} + {P}_{T , t - Δ t} \qquad ( 16 )$$

$${T}_{H , t}^{o} = \frac{{K}_{H 1} {T}_{H , t - Δ t}^{o} + Δ t {ϕ}_{H , t} + Δ {tC}_{p} {m}_{H , t} {T}_{H , t}^{i}}{( {K}_{H 1} + Δ {tC}_{w} {m}_{H} + Δ {tK}_{H 2} )} \qquad ( 17 )$$

where Δt is a time step, and P_{B,t-Δt}, P_{T,t-Δt} and T_{H,t-Δt}^{e} represent a pressure of the coal-fired boiler, an electric power inputted to the steam turbine, and an outlet temperature of the steam-water heat exchanger at time t−Δt.

The process of constructing, in combination with operational security constraints, a security region model of the integrated electricity and heating system considering thermal dynamics includes the following steps.

The operational security constraints of the power system include branch transmission power constraints, upper and lower limit constraints of generator active and reactive powers, upper and lower limit constraints of node voltage amplitude, and voltage phase angle constraints, as shown in Equations (18) to (21) respectively:

$$\sqrt{{P}_{l , ij , t}^{2} + {Q}_{l , ij , t}^{2}} \leq {S}_{l , ij}^{m a x} \qquad ( 18 )$$

$${{P}_{Gi}^{m i n}}^{} \leq {P}_{Gi , t} \leq {P}_{Gi}^{m a x} , \qquad ( 19 )$$

$${Q}_{Gi}^{m i n} \leq {Q}_{Gi , t} \leq {Q}_{Gi}^{m a x}$$

$${{V}_{i}^{m i n}}^{} \leq {V}_{i , t} \leq {V}_{i}^{m a x} \qquad ( 20 )$$

$${- π}^{} \leq {θ}_{i , t} \leq π \qquad ( 21 )$$

where S_{l,ij}^{max} represents a maximum apparent power transmitted between node i and node j, P_{Gi}^{min} and Q_{Gi}^{min} respectively represent the lower limits of the generator active and reactive powers at node i, P_{Gi}^{min} and Q_{Gi}^{min} respectively represent the upper limits of the generator active and reactive powers at node i, and Vᵢ^{min} and Vᵢ^{max} respectively represent the lower and upper limits of the voltage amplitude at node i.

Furthermore, coupling constraints of the power system and the combined heat and power unit may be represented as:

$${P}_{T , t} = {P}_{G , t} \qquad ( 22 )$$

The operational security constraints of the quality-regulated heating system mainly include node water supply and return temperature constraints, which may be represented as:

T_{i,t}^{s,min}≤T_{i,t}^{s}≤T_{i,t}^{s,max},T_{i,t}^{r,min}≤T_{i,t}^{r}≤T_{i,t}^{r,max}iϵΘ (23)
where T_{i,t}^{s,max} and T_{i,t}^{s,min} represent the upper and lower limits of the water supply temperature of node i at time t, T_{i,t}^{r,max} and T_{i,t}^{r,min} represent the upper and lower limits of the water return temperature of node i at time t, and coupling constraints of the heating system and the combined heat and power unit may be represented as:

$${m}_{G} = - {m}_{H} \qquad ( 24 )$$

$${T}_{H , t}^{o} = {T}_{G , t}^{s} , \qquad ( 25 )$$

$${T}_{H , t}^{i} = {T}_{G , t}^{r}$$

where T_{G,t}^{s} represents the water supply temperature of a heat source node at time t, T_{G,t}^{r} represents the water return temperature of the heat source node at time t, Equation (24) shows that the inlet and outlet mass flow rate of the steam-water heat exchanger is the mass flow rate of the heat source node, and Equation (25) shows that the outlet temperature of the steam-water heat exchanger is the water supply temperature of the heat source node and the inlet temperature of the steam-water heat exchanger is the water return temperature of the heat source node.

The operational security constraints of the combined heat and power unit mainly include mass flow rate constraints of input fuel, pressure constraints of the coal-fired boiler, pressure constraints of the steam turbine, heating power constraints, supply power constraints, and electric heating power coupling constraints, as shown in Equations (26) to (31)(31) respectively:

$${m}_{B}^{m i n} \leq {m}_{B , t} \leq {m}_{B}^{m a x} \qquad ( 26 )$$

$${p}_{B}^{m i n} \leq {p}_{B , t} \leq {p}_{B}^{m a x} \qquad ( 27 )$$

$${p}_{T}^{m i n} \leq {p}_{T , t} \leq {p}_{T}^{m a x} \qquad ( 28 )$$

$${{ϕ}_{H}^{m i n}}^{} \leq {ϕ}_{H , t} \leq {ϕ}_{H}^{m a x} \qquad ( 29 )$$

$${{P}_{T}^{m i n}}^{} \leq {P}_{T , t} \leq {P}_{T}^{m a x} \qquad ( 30 )$$

$${P}_{T , t} + {ϕ}_{H , t} \leq {K}_{B 2} {ϕ}_{B , t} \qquad ( 31 )$$

In combination with the operational security constraints of each system, the security region model of the integrated electricity and heating system is established. First, variables of the integrated electricity and heating system at any time t are divided into a controllable variable Xₜ and a controlled variable Yₜ. The controllable variable includes an active power of a generator in the power system, input fuel mass in the combined heat and power unit, a heat supply power of a heat source in the heating system, and a water supply temperature, which are respectively represented as:

$$\{ \begin{matrix}{X}_{t} = \{ {X}_{t}^{e} , {X}_{t}^{c} , {X}_{t}^{h} \} \\ {X}_{t}^{e} = \{ {P}_{G , t} \} , {X}_{t}^{c} = \{ {m}_{B , t} \} , {X}_{t}^{h} = \{ {ϕ}_{G , t} , {T}_{G , t}^{s} \}\end{matrix} \qquad ( 32 )$$

where Xₜ^{e} represents the controllable variable in the power system at time t, Xₜ^{h} represents the controllable variable in the heating system at time t, Xₜ^{c} represents the controllable variable in the combined heat and power unit at time t, and ϕ_{G,t} represents the heat supply power of the heat source node at time t.

The controlled variable includes branch active and reactive powers in the power system, a node voltage amplitude and phase angle, a water return temperature of the heat source node in the heating system, a water supply temperature of a load node, input heat in the combined heat and power unit, pressures of the coal-fired boiler and the steam turbine, an outlet temperature of the steam-water heat exchanger, and a supply power, which may be represented as:

$$\{ \begin{matrix}{Y}_{t} = \{ {Y}_{t}^{e} , {Y}_{t}^{c} , {Y}_{t}^{h} \} \\ {Y}_{t}^{e} = \{ {P}_{l , t} , {Q}_{l , t} , {V}_{t} , {θ}_{t} \} \\ {Y}_{t}^{c} = \{ {ϕ}_{B , t} , {p}_{B , t} , {p}_{T , t} , {P}_{T , t} , {T}_{S , t}^{o} \} \\ {Y}_{t}^{h} = \{ {T}_{G , t}^{r} , {T}_{D , t}^{s} \}\end{matrix} \qquad ( 33 )$$

where Yₜ^{e} represents the controlled variable in the power system at time t, Yₜ^{h} represents the controlled variable in the heating system at time t, Yₜ^{c} represents the controlled variable in the combined heat and power unit at time t, and T_{D,t}^{s} represents the water supply temperature of the load node at time t.

Therefore, the security region Ωⱼ of the integrated electricity and heating system considering thermal dynamics at time j may be represented as:

$${Ω}_{j} = \{ \begin{matrix}{X}_{j} \vert f ( {X}_{1} , … , {X}_{j} , {Y}_{1} , … , {Y}_{j} ) = 0 , \\ g ( {X}_{1} , … , {X}_{j} , {Y}_{1} , … , {Y}_{j} ) \leq 0\end{matrix} \} \qquad ( 34 )$$

where Ωⱼ represents the security region, X₁, . . . , Xⱼ represent the controllable variables from time 1 to time j, Y₁, . . . , Yⱼ represent the controlled variables from time 1 to time j, f is an equality constraint set in the security region model, including Equations (1) to (4), (6) to (10), (13), (15) to (17), (22), (24), and (25), and g is an inequality constraint set in the security region model, including Equations (18) to (21), (23), (26) to (31).

The process of solving, aiming at nonlinear and nonconvex characteristics of the security region of the integrated electricity and heating system, a security region boundary by adopting an optimization-check-based concave hull method, and depicting the security region includes the following steps.

A security region modeling problem is transformed into a security region boundary solving problem. Equation (34) is transformed into two groups of nonlinear optimization problems, and the security region boundary is depicted by solving a limit operation point. The two groups of optimization problems may be respectively represented as:

$$min {F}_{j , i} \qquad ( 35 )$$

$$s . t .$$

$$f ( {X}_{1} , … , {X}_{j} , {Y}_{1} , … , {Y}_{j} ) = 0$$

$${A}_{1} \leq g ( {X}_{1} , … , {X}_{j} , {Y}_{1} , … , {Y}_{j} ) \leq {A}_{2}$$

$${F}_{j} = [ {X}_{j} , {Y}_{j} ] ,$$

$$∀ {F}_{j , i} ∈ {F}_{j}$$

$$max {F}_{j , i} \qquad ( 36 )$$

$$s . t .$$

$$f ( {X}_{1} , … , {X}_{j} , {Y}_{1} , … , {Y}_{j} ) = 0$$

$${A}_{1} \leq g ( {X}_{1} , … , {X}_{j} , {Y}_{1} , … , {Y}_{j} ) \leq {A}_{2}$$

$${F}_{j} = [ {X}_{j} , {Y}_{j} ] ,$$

$$∀ {F}_{j , i} ∈ {F}_{j}$$

Equation (35) and Equation (36) respectively represent operational upper and lower limits of the integrated electricity and heating system considering thermal dynamics. Fⱼ represents all state variable vectors in the integrated electricity and heating system at time j, F_{j,i} represents an i^{th} variable in the integrated electricity and heating system at time j, A₁ represents a lower limit vector of an inequality constraint, and A₂ represents an upper limit vector of the inequality constraint.

Security check is performed on the limit operation point solved by Equation (35) and Equation (36) in view of the nonconvex and nonlinear features of the security region model. ε is defined as a security margin. If the solved i^{th} variable F_{j,i} in the integrated electricity and heating system at time j violates the upper limit of security operation, the corresponding optimization problem is modified as:

$$min {F}_{j , i} \qquad ( 37 )$$

$$s . t .$$

$$f ( {X}_{1} , … , {X}_{j} , {Y}_{1} , … , {Y}_{j} ) = 0$$

$${A}_{1} \leq g ( {X}_{1} , … , {X}_{j} , {Y}_{1} , … , {Y}_{j} ) \leq {A}_{2} - ε$$

If the solved i^{th} variable F_{j,i} in the integrated electricity and heating system at time j violates the upper limit of security operation, the corresponding optimization problem is modified as:

$$min {F}_{j , i} \qquad ( 38 )$$

$$s . t .$$

$$f ( {X}_{1} , … , {X}_{j} , {Y}_{1} , … , {Y}_{j} ) = 0$$

$${A}_{1} + ε \leq g ( {X}_{1} , … , {X}_{j} , {Y}_{1} , … , {Y}_{j} ) \leq {A}_{2}$$

The security region boundary is depicted by adopting the concave hull method according to the limit operation point satisfying the security check, and the security region of the integrated electricity and heating system considering thermal dynamics is constructed.

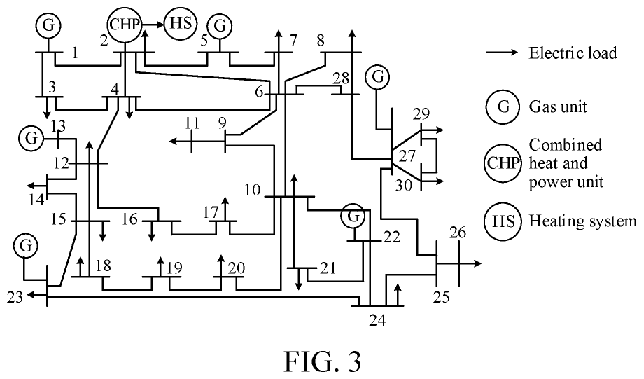

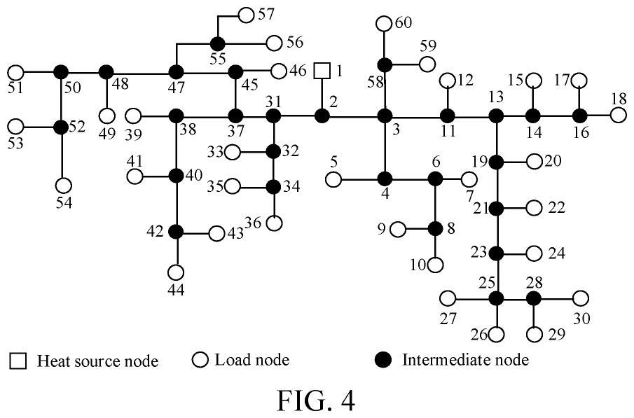

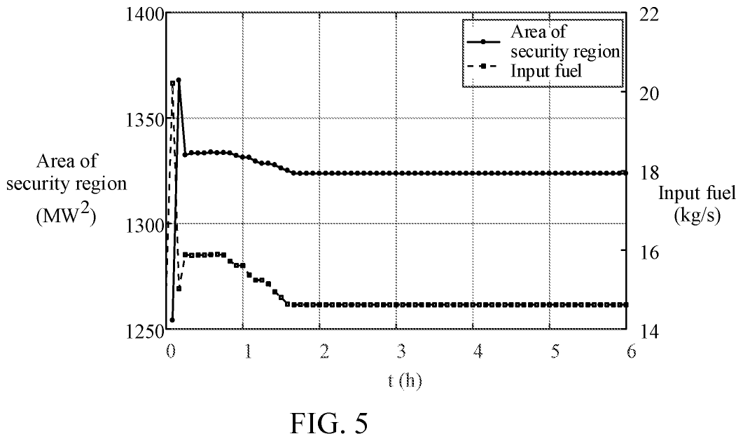

The system shown in FIG. 2 is taken as an example. The structure of the heating system is shown in FIG. 3. A calculation period is 6 hours, and a time step is 5 minutes. The simulated operational characteristics of the combined heat and power unit are shown in FIG. 4. A time-varying curve of an area of a security region of generator 1 and generator 2 calculated by adopting the optimization-check-based concave hull method is shown in FIG. 5.

The basic principles, main features, and advantages of the present disclosure are shown and described above. Those skilled in the art will appreciate that the present disclosure is not limited by the foregoing embodiments, that the foregoing embodiments and descriptions are merely illustrative of the principles of the present disclosure, and that various variations and modifications may be made to the present disclosure without departing from the spirit and scope of the present disclosure. The variations and modifications fall within the claimed scope of the present disclosure.

What is claimed is:

1. A method for constructing a security region of an integrated electricity and heating system, comprising the following steps:
establishing a dynamic model of the integrated electricity and heating system, comprising a power system model established based on power conservation, a dynamic model of a quality-regulated heating system model established based on pipe heat transfer, node heat exchange, node temperature fusion, and pipe-node temperature association, and a dynamic model of a combined heat and power unit constructed based on production capacity of the combined heat and power unit; and
constructing, in combination with operational security constraints of the dynamic model of the integrated electricity and heating system, a security region model of the integrated electricity and heating system, solving, aiming at nonlinear and nonconvex characteristics of the security region of the integrated electricity and heating system, a security region boundary by adopting a concave hull method, and depicting the security region.

2. The method for constructing the security region of the integrated electricity and heating system according to claim 1, wherein the power system model comprises a power conservation equation and a power conservation equation at nodes and branches:
$${P}_{Gi , t} - {P}_{Li , t} = {V}_{i , t} {\sum }_{j ∈ i} {V}_{j , t} ( {G}_{ij} cos {θ}_{ij , t} + {B}_{ij} sin {θ}_{ij , t} ) \qquad ( 1 )$$
$${Q}_{Gi , t} - {Q}_{Li , t} = {V}_{i , t} {\sum }_{j ∈ i} {V}_{j , t} ( {G}_{ij} sin {θ}_{ij , t} - {B}_{ij} cos {θ}_{ij , t} ) \qquad ( 2 )$$
$${P}_{l , ij , t} = {V}_{i , t} {V}_{j , t} ( {G}_{ij} cos {θ}_{ij , t} + {B}_{ij} sin {θ}_{ij , t} ) - {G}_{ij} {V}_{i , t}^{2} \qquad ( 3 )$$
$${Q}_{l , ij , t} = {V}_{i , t} {V}_{j , t} ( {G}_{ij} sin {θ}_{ij , t} + {B}_{ij} cos {θ}_{ij , t} ) + {B}_{ij} {V}_{i , t}^{2} \qquad ( 4 )$$
wherein i and j represent node numbers respectively, t is a time flag, V_{i,t} represents a voltage amplitude of node i at time t, P_{Gi,t} and P_{Li,t} represent a generator produced active power and a load consumed active power of node i at time t, Q_{Gi,t} and Q_{Li,t} represent a generator produced reactive power and a load consumed reactive power of node i at time t, Gᵢⱼ and Bᵢⱼ represent conductance and susceptance between node i and node j, θ_{ij,t} represents a phase angle difference between node i and node j at time t, and P_{1,ij,t} and Q_{1,ij,t} represent an active power and a reactive power transmitted between node i and node j at time t.

3. The method for constructing the security region of the integrated electricity and heating system according to claim 1, wherein the dynamic model of the quality-regulated heating system model comprises a pipe heat transfer equation, a node heat exchange equation, a node temperature fusion equation, and a pipe-node temperature association equation:
$$\frac{\partial {T}_{j , x , t}}{\partial t} + {v}_{j} \frac{\partial {T}_{j , x , t}}{\partial x} + \frac{{v}_{j}}{{C}_{w} {m}_{j} {λ}_{j}} {T}_{j , x , t} = 0 \qquad ( 5 )$$
$$j ∈ Φ$$
$${ϕ}_{i , t} = {C}_{w} {m}_{i} ( {T}_{i , t}^{s} - {T}_{i , t}^{r} ) \qquad ( 6 )$$
$$i ∈ Θ$$
$${T}_{j , t} {\sum }_{k ∈ {Φ}_{j}^{i}} {m}_{k} = {\sum }_{k ∈ {Φ}_{j}^{o}} {m}_{k} {T}_{k , x = L , t} \qquad ( 7 )$$
$$j ∈ Θ$$
$${T}_{k , x = 0 , t} = {T}_{j , t} \qquad ( 8 )$$
$$j ∈ Θ ,$$
$$k ∈ {Φ}_{j}^{i}$$
wherein Φ and Θ represent a pipe set and a node set of the heating system respectively, T_{j,x,t} represents a relative temperature at x on pipe j at time t, vⱼ represents a water flow velocity of pipe j, C_{w} is the specific heat capacity of water, mⱼ is the mass flow rate of pipe water flow, λⱼ represents a thermal resistance coefficient of pipe j, ϕ_{i,t} represents a consumed thermal power of node i at time t, Ts i,t and T_{i,t}^{r} represent relative water supply and return temperatures of node i at time t, L represents a pipe length, and Φⱼⁱ and Φⱼ⁰ represent pipe sets flowing into and out of node j respectively; and
an analytical solution of Equation (5) is represented as:
$${T}_{j , x , t} = {φ}_{j , x - vt} {e}^{- vt / {C}_{w} {m}_{j} {λ}_{j}} [ δ ( t ) - δ ( t - x / v ) ] + {ψ}_{j , t - x / v} {e}^{- x / {C}_{w} {m}_{j} {λ}_{j}} δ ( t - x / v ) \qquad ( 9 )$$
$$0 \leq x \leq L ,$$
$$j ∈ Φ$$
wherein δ represents a step function, φ(j,x−vt) represents a temperature distribution at x−vt on pipe j at an initial time, and ψ(j,t−x/v) represents a temperature distribution at an inlet of pipe j at time t−x/v.

4. The method for constructing the security region of the integrated electricity and heating system according to claim 1, wherein the dynamic model of the combined heat and power unit comprises a coal-fired boiler, a steam turbine, a generator, and a steam-water heat exchanger, and the dynamic model of the combined heat and power unit is constructed as follows:
input fuel of the coal-fired boiler is represented as:
$${ϕ}_{B , t} = {K}_{B 1} {m}_{B , t} \qquad ( 10 )$$
wherein K_{B1} is a unit heat value of the fuel, ϕ_{B,t} represents input heat of the boiler at time t, and m_{B,t} represents a mass flow rate inputted to the boiler at time t;
energy conservation in the boiler is represented as:
$${K}_{B 3} \frac{{dp}_{B , t}}{dt} = - {K}_{T 1} {p}_{T , t} - {ϕ}_{H , t} + {K}_{B 2} {ϕ}_{B , t} \qquad ( 11 )$$
wherein K_{B2} is combustion efficiency of the boiler, K_{B3} is a heat storage coefficient of the boiler, K_{T1} is a gain of the boiler, p_{T,t} is a pressure of the steam turbine at time t, ϕ_{H,t} represents a heat supply power at time t, and p_{B,t} is a pressure of the coal-fired boiler at time t;
energy conservation in the steam turbine is represented as:
$${K}_{T 4} \frac{{dP}_{T , t}}{dt} = - {P}_{T , t} + {K}_{T 2} {K}_{T 3} {p}_{T , t} \qquad ( 12 )$$
wherein K_{T2} is an inlet opening of the steam turbine, K_{T3} is a gain of the steam turbine, K_{T4} is a delay coefficient of the steam turbine, and P_{T,t} is an electric power generated by the steam turbine at time t;
the pressure of the coal-fired boiler and the pressure of the steam turbine satisfy:
$${p}_{T , t} = {p}_{B , t} - {K}_{B 4} {K}_{B 2}^{1.3} {ϕ}_{B , t}^{1.3} \qquad ( 13 )$$
wherein K_{B4} is a friction resistance coefficient of the boiler;
energy conservation in the steam-water heat exchanger is represented as:
$$\frac{{dT}_{H , t}^{o}}{dt} = \frac{{ϕ}_{H , t}}{{K}_{H 1}} - \frac{{C}_{w} {m}_{H} ( {T}_{H , t}^{o} - {T}_{H , t}^{i} )}{{K}_{H 1}} - \frac{{K}_{H 2} {T}_{H , t}^{o}}{{K}_{H 1}} \qquad ( 14 )$$
wherein K_{H1} represents a heat storage coefficient of the heat exchanger, K_{H2} represents a thermal conductivity coefficient of the heat exchanger, m_{H,t} represents a mass flow rate of water flow for heat exchange in the heat exchanger at time t, T_{H,t}ⁱ and T_{H,t}^{o} represent inlet and outlet temperatures of the steam-water heat exchanger at time t; and
an ordinary differential equation is discretized by using an implicit Euler method, and Equations (11), (12), and (14) are respectively discretized as:
$${p}_{B , t} = \frac{Δ t ( {K}_{B 2} {K}_{B 1} {m}_{B , t} - {K}_{T 1} {p}_{T , t} - {ϕ}_{S , t} )}{{K}_{B 3}} + {p}_{B , t - Δ t} \qquad ( 15 )$$
$${P}_{T , t} = \frac{Δ t ( {K}_{T 2} {K}_{T 3} {p}_{T , t} - {P}_{T , t} )}{{K}_{T 4}} + {P}_{T , t - Δ t} \qquad ( 16 )$$
$${T}_{H , t}^{o} = \frac{{K}_{H 1} {T}_{H , t - Δ t}^{o} + Δ t {ϕ}_{H , t} + Δ {tC}_{p} {m}_{H , t} {T}_{H , t}^{i}}{( {K}_{H 1} + Δ {tC}_{w} {m}_{H} + Δ {tK}_{H 2} )} \qquad ( 17 )$$
wherein Δt is a time step, and p_{B,t-Δt}, P_{T,t-Δt}, and T_{H,t-Δt}^{o} represent a pressure of the coal-fired boiler, an electric power inputted to the steam turbine, and an outlet temperature of the steam-water heat exchanger at time t−Δt.

5. The method for constructing the security region of the integrated electricity and heating system according to claim 1, wherein the operational security constraints of the dynamic model of the integrated electricity and heating system comprise operational security constraints of the power system model, operational security constraints of the dynamic model of the quality-regulated heating system model, and operational security constraints of the dynamic model of the combined heat and power unit:
the operational security constraints of the power system comprise branch transmission power constraints, upper and lower limit constraints of generator active and reactive powers, upper and lower limit constraints of node voltage amplitude, and voltage phase angle constraints, as shown in Equations (18) to (21) respectively:
$$\sqrt{{P}_{l , ij , t}^{2} + {Q}_{l , ij , t}^{2}} \leq {S}_{l , ij}^{m a x} \qquad ( 18 )$$
$${{P}_{Gi}^{m i n}}^{} \leq {P}_{Gi , t} \leq {P}_{Gi}^{m a x} , \qquad ( 19 )$$
$${Q}_{Gi}^{m i n} \leq {Q}_{Gi , t} \leq {Q}_{Gi}^{m a x}$$
$${{V}_{i}^{m i n}}^{} \leq {V}_{i , t} \leq {V}_{i}^{m a x} \qquad ( 20 )$$
$${- π}^{} \leq {θ}_{i , t} \leq π \qquad ( 21 )$$
wherein S_{l,ij}^{max} represents a maximum apparent power transmitted between node i and node j, P_{Gi}^{min} and Q_{Gi}^{min} respectively represent the lower limits of the generator active and reactive powers at node i, P_{Gi}^{min} and Q_{Gi}^{min} respectively represent the upper limits of the generator active and reactive powers at node i, and Vᵢ^{min} and Vᵢ^{max} respectively represent the lower and upper limits of the voltage amplitude at node i;
coupling constraints of the power system and the combined heat and power unit are represented as:
$${P}_{T , t} = {P}_{G , t} \qquad ( 22 )$$
the operational security constraints of the quality-regulated heating system comprise node water supply and return temperature constraints, which are represented as:
T_{i,t}^{s,min}≤T_{i,t}^{s}≤T_{i,t}^{s,max},T_{i,t}^{r,min}≤T_{i,t}^{r}≤T_{i,t}^{r,max}iϵΘ (23)
wherein T_{i,t}^{max} and T_{i,t}^{s,min} represent the upper and lower limits of the water supply temperature of node i at time t, T_{i,t}^{r,max} and T_{i,t}^{r,min} represent the upper and lower limits of the water return temperature of node i at time t, and coupling constraints of the heating system and the combined heat and power unit are represented as:
$${m}_{G} = - {m}_{H} \qquad ( 24 )$$
$${T}_{H , t}^{o} = {T}_{G , t}^{s} , \qquad ( 25 )$$
$${T}_{H , t}^{i} = {T}_{G , t}^{r}$$
wherein T_{G,t}^{s} represents the water supply temperature of a heat source node at time t, T_{G,t}^{r} represents the water return temperature of the heat source node at time t, Equation (24) shows that the inlet and outlet mass flow rate of the steam-water heat exchanger is the mass flow rate of the heat source node, and Equation (25) shows that the outlet temperature of the steam-water heat exchanger is the water supply temperature of the heat source node and the inlet temperature of the steam-water heat exchanger is the water return temperature of the heat source node; and
the operational security constraints of the combined heat and power unit comprise mass flow rate constraints of input fuel, pressure constraints of the coal-fired boiler, pressure constraints of the steam turbine, heating power constraints, supply power constraints, and electric heating power coupling constraints, as shown in Equations (26) to (31) respectively:
$${m}_{B}^{m i n} \leq {m}_{B , t} \leq {m}_{B}^{m a x} \qquad ( 26 )$$
$${p}_{B}^{m i n} \leq {p}_{B , t} \leq {p}_{B}^{m a x} \qquad ( 27 )$$
$${p}_{T}^{m i n} \leq {p}_{T , t} \leq {p}_{T}^{m a x} \qquad ( 28 )$$
$${{ϕ}_{H}^{m i n}}^{} \leq {ϕ}_{H , t} \leq {ϕ}_{H}^{m a x} \qquad ( 29 )$$
$${{P}_{T}^{m i n}}^{} \leq {P}_{T , t} \leq {P}_{T}^{m a x} \qquad ( 30 )$$
$${P}_{T , t} + {ϕ}_{H , t} \leq {K}_{B 2} {ϕ}_{B , t} . \qquad ( 31 )$$

6. The method for constructing the security region of the integrated electricity and heating system according to claim 5, wherein the security region model of the integrated electricity and heating system is constructed as follows:
variables of the integrated electricity and heating system at any time t are divided into a controllable variable Xₜ and a controlled variable Yₜ, the controllable variable comprises an active power of a generator in the power system, input fuel mass in the combined heat and power unit, a heat supply power of a heat source in the heating system, and a water supply temperature, which are respectively represented as:
$$\{ \begin{matrix}{X}_{t} = \{ {X}_{t}^{e} , {X}_{t}^{c} , {X}_{t}^{h} \} \\ {X}_{t}^{e} = \{ {P}_{G , t} \} , {X}_{t}^{c} = \{ {m}_{B , t} \} , {X}_{t}^{h} = \{ {ϕ}_{G , t} , {T}_{G , t}^{s} \}\end{matrix} \qquad ( 32 )$$
wherein Xₜ^{e} represents the controllable variable in the power system at time t, Xₜ^{h} represents the controllable variable in the heating system at time t, Xₜ^{c} represents the controllable variable in the combined heat and power unit at time t, and ϕ_{G,t} represents the heat supply power of the heat source node at time t;
the controlled variable comprises branch active and reactive powers in the power system, a node voltage amplitude and phase angle, a water return temperature of the heat source node in the heating system, a water supply temperature of a load node, input heat in the combined heat and power unit, pressures of the coal-fired boiler and the steam turbine, an outlet temperature of the steam-water heat exchanger, and a supply power, which are represented as:
$$\{ \begin{matrix}{Y}_{t} = \{ {Y}_{t}^{e} , {Y}_{t}^{c} , {Y}_{t}^{h} \} \\ {Y}_{t}^{e} = \{ {P}_{l , t} , {Q}_{l , t} , {V}_{t} , {θ}_{t} \} \\ {Y}_{t}^{c} = \{ {ϕ}_{B , t} , {p}_{B , t} , {p}_{T , t} , {P}_{T , t} , {T}_{S , t}^{o} \} \\ {Y}_{t}^{h} = \{ {T}_{G , t}^{r} , {T}_{D , t}^{s} \}\end{matrix} \qquad ( 33 )$$
wherein Yₜ^{e} represents the controlled variable in the power system at time t, Yₜ^{h} represents the controlled variable in the heating system at time t, Yₜ^{e} represents the controlled variable in the combined heat and power unit at time t, and T_{D,t}^{s} represents the water supply temperature of the load node at time t;
the security region model of the integrated electricity and heating system considering thermal dynamics is represented as:
$${Ω}_{j} = \{ \begin{matrix}{X}_{j} \vert f ( {X}_{1} , … , {X}_{j} , {Y}_{1} , … , {Y}_{j} ) = 0 , \\ g ( {X}_{1} , … , {X}_{j} , {Y}_{1} , … , {Y}_{j} ) \leq 0\end{matrix} \} \qquad ( 34 )$$
wherein Ωⱼ represents the security region, X₁, . . . , Xⱼ represent the controllable variables from time 1 to time j, Y₁, . . . , Yⱼ represent the controlled variables from time 1 to time j, f is an equality constraint set in the security region model, comprising Equations (1) to (4), (6) to (10), (13), (15) to (17), (22), (24), and (25), and g is an inequality constraint set in the security region model, comprising Equations (18) to (21), (23), (26) to (31).

7. The method for constructing the security region of the integrated electricity and heating system according to claim 6, wherein the solving, aiming at nonlinear and nonconvex characteristics of the security region of the integrated electricity and heating system, a security region boundary by adopting a concave hull method and depicting the security region comprises the following steps:
transforming a security region modeling problem into a security region boundary solving problem, transforming Equation (34) into two groups of nonlinear optimization problems, and depicting the security region boundary by solving a limit operation point, the two groups of optimization problems being respectively represented as:
$$min {F}_{j , i} \qquad ( 35 )$$
$$s . t .$$
$$f ( {X}_{1} , … , {X}_{j} , {Y}_{1} , … , {Y}_{j} ) = 0$$
$${A}_{1} \leq g ( {X}_{1} , … , {X}_{j} , {Y}_{1} , … , {Y}_{j} ) \leq {A}_{2}$$
$${F}_{j} = [ {X}_{j} , {Y}_{j} ] ,$$
$$∀ {F}_{j , i} ∈ {F}_{j}$$
$$max {F}_{j , i} \qquad ( 36 )$$
$$s . t .$$
$$f ( {X}_{1} , … , {X}_{j} , {Y}_{1} , … , {Y}_{j} ) = 0$$
$${A}_{1} \leq g ( {X}_{1} , … , {X}_{j} , {Y}_{1} , … , {Y}_{j} ) \leq {A}_{2}$$
$${F}_{j} = [ {X}_{j} , {Y}_{j} ] ,$$
$$∀ {F}_{j , i} ∈ {F}_{j}$$
wherein Equation (35) and Equation (36) respectively represent operational upper and lower limits of the integrated electricity and heating system considering thermal dynamics, Fⱼ represents all state variable vectors in the integrated electricity and heating system at time j, F_{j,i} represents an i^{th} variable in the integrated electricity and heating system at time j, A₁ represents a lower limit vector of an inequality constraint, and A₂ represents an upper limit vector of the inequality constraint;
performing security check on the limit operation point solved by Equation (35) and Equation (36) in view of the nonconvex and nonlinear features of the security region model, defining ε as a security margin, and if the solved i^{th} variable F_{j,i} in the integrated electricity and heating system at time j violates the upper limit of security operation, modifying the corresponding optimization problem as:
$$min {F}_{j , i} \qquad ( 37 )$$
$$s . t .$$
$$f ( {X}_{1} , … , {X}_{j} , {Y}_{1} , … , {Y}_{j} ) = 0$$
$${A}_{1} \leq g ( {X}_{1} , … , {X}_{j} , {Y}_{1} , … , {Y}_{j} ) \leq {A}_{2} - ε$$
if the solved i^{th} variable F_{j,i} in the integrated electricity and heating system at time j violates the upper limit of security operation, modifying the corresponding optimization problem as:
$$min {F}_{j , i} \qquad ( 38 )$$
$$s . t .$$
$$f ( {X}_{1} , … , {X}_{j} , {Y}_{1} , … , {Y}_{j} ) = 0$$
$${A}_{1} + ε \leq g ( {X}_{1} , … , {X}_{j} , {Y}_{1} , … , {Y}_{j} ) \leq {A}_{2}$$
depicting the security region boundary by adopting the concave hull method according to the limit operation point satisfying the security check, and determining the security region of the integrated electricity and heating system considering thermal dynamics.
